(19) United States
(12) Patent Application Publication
(10) Pub. No.: US 2026/0250450 A1
(43) Pub. Date: Aug. 27, 2026

(54) PROCESS FOR REVERSIBLE CROSSLINK COMPOSITION

(71) Applicant: Dow Global Technologies LLC, Midland, MI (US)

(72) Inventors: Lin Jin, Pearland, TX (US); Gaoxiang Wu, Houston, TX (US); Colin Li Pi Shan, Pearland, TX (US); Jeffrey C. Munro, Bellaire, TX (US)

(21) Appl. No.: 18/992,484

(22) PCT Filed: Jul. 14, 2023
(86) PCT No.: PCT/US2023/027822

§ 371 Date: Jan. 8, 2025

Related U.S. Application Data
(60) Provisional application No. 63/389,707, filed on Jul. 15, 2022.
(60) Provisional application No. 63/389,738, filed on Jul. 15, 2022.

(51) Int. Cl. C08F 255/02; B29B 17/04; B29C 48/00; B29K 96/02; C08J 3/14; C08J 3/20; C08J 3/24; C08J 11/12

(52) U.S. Cl. CPC C08F 255/02; B29B 17/04; B29C 48/022; C08J 3/14; C08J 3/201; C08J 3/203; C08J 3/247; C08J 11/12; B29B 2017/0468; B29K 2096/02; C08F 2400/02; C08J 2351/06

(57) ABSTRACT

The present disclosure provides a process. In an embodiment, the process includes feeding into a mixing device components. The components include comprising (i) a (polar) ethylene-based polymer having a melt temperature, Tm, (ii) a free radical initiator having a decomposition temperature, Tdecomp, and (iii) 2,2,6,6-tetramethyl-4-piperidyl methacrylate disulfide (BiTEMPS methacrylate). The process includes mixing, in the mixing device, components (i), (ii), and (iii) at a temperature less than the decomposition temperature of the free radical initiator. The process includes forming a crosslinkable polymer composition comprising the (polar) ethylene-based polymer the BITEMPS methacrylate, and the free radical initiator.

### BACKGROUND

Crosslinked olefin-based polymers (and crosslinked ethylene-based polymers in particular) are well-known in myriad applications because of their excellent mechanical properties, high heat stability, and outstanding chemical resistance. Unfortunately, crosslinked ethylene-based polymer (also known as thermoset polymer) is unable to be reprocessed and/or recycled due to the presence of the permanent crosslinked network within the ethylene-based polymer. Thus, the use of crosslinked ethylene-based polymer carries concomitant environmental and sustainability concerns.

The ability to reprocess and/or recycle crosslinked ethylene-based polymer has been a long-standing challenge. Consequently, the art recognizes the need for a crosslinked olefin-based polymer (and a crosslinked ethylene-based polymer in particular) that can be reprocessed and/or recycled.

### SUMMARY

The present disclosure provides a process. In an embodiment, the process includes feeding components into a mixing device. The components include (i) a (polar) ethylene-based polymer having a melt temperature, Tm, (ii) a free radical initiator having a decomposition temperature, T_{decomp}, and (iii) 2,2,6,6-tetramethyl-4-piperidyl methacrylate disulfide (BiTEMPS methacrylate). The process includes mixing, in the mixing device, components (i), (ii), and (iii) at a temperature less than the decomposition temperature of the free radical initiator. The process includes forming a crosslinkable polymer composition comprising the (polar) ethylene-based polymer the BiTEMPS methacrylate, and the free radical initiator.

### Definitions

All references to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight. For purposes of United States patent practice, the contents of any patent, patent application, or publication referenced herein are hereby incorporated by reference in their entirety (or the equivalent US version thereof is so incorporated by reference).

The numerical ranges disclosed herein include all values from, and including, the lower value and the upper value. For ranges containing explicit values (e.g., a range from 1, or 2, or 3 to 5, or 6, or 7) any subrange between any two explicit values is included (e.g., the range 1-7 above includes subranges from 1 to 2; from 2 to 6; from 5 to 7; from 3 to 7; from 5 to 6; etc.).

Unless stated to the contrary, implicit from the context, or customary in the art, all parts and percentages are based on weight, and all test methods are current as of the filing date of this disclosure.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

An “ethylene-based polymer” is a polymer that contains more than 50 mol % polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE) and linear polyethylene. Nonlimiting examples of linear polyethylene include linear low density polyethylene (LLDPE), ultra low density polyethylene (ULDPE), very low density polyethylene (VLDPE), ethylene/α-olefin multi-block copolymers (also known as olefin block copolymer (OBC)), substantially linear, or linear, plastomers/elastomers, and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or multiple reactor configurations.

“Ethylene plastomers/elastomers” are substantially linear, or linear, ethylene/α-olefin interpolymers containing homogeneous short-chain branching distribution comprising units derived from ethylene and units derived from at least one C₃-C₁₀ α-olefin comonomer. Ethylene plastomers/elastomers have a density from 0.854 g/cc to 0.920 g/cc. Nonlimiting examples of ethylene plastomers/elastomers include AFFINITY™ Polyolefin Plastomers and ENGAGE™ Polyolefin Elastomers (available from The Dow Chemical Company), EXACT™ Plastomers (available from ExxonMobil Chemical), Tafmer™ Alpha-olefin copolymers (available from Mitsui), Solumer™ Polyolefin Elastomers and Supreme™ Polyolefin Plastomers (available from SK Chemicals Co.), and Lucene™ Polyolefin Elastomers (available from LG Chem Ltd.).

“High density polyethylene” (or “HDPE”) is an ethylene homopolymer or an ethylene/α-olefin copolymer with at least one C₄-C₁₀ α-olefin comonomer, or C₄-C₈ α-olefin comonomer and a density from 0.940 g/cc, or 0.945 g/cc, or 0.950 g/cc, or 0.953 g/cc to 0.955 g/cc, or 0.960 g/cc, or 0.965 g/cc, or 0.970 g/cc, or 0.975 g/cc, or 0.980 g/cc. The HDPE can be a monomodal copolymer or a multimodal copolymer. A “monomodal ethylene copolymer” is an ethylene/C₄-C₁₀ α-olefin copolymer that has one distinct peak in a gel permeation chromatography (GPC) showing the molecular weight distribution. A “multimodal ethylene copolymer” is an ethylene/C₄-C₁₀ α-olefin copolymer that has at least two distinct peaks in a GPC showing the molecular weight distribution. Multimodal includes copolymer having two peaks (bimodal) as well as copolymer having more than two peaks. Nonlimiting examples of HDPE include DOW™ High Density Polyethylene (HDPE) Resins (available from The Dow Chemical Company), ELITE™ Enhanced Polyethylene Resins (available from The Dow Chemical Company), CONTINUUM™ Bimodal Polyethylene Resins (available from The Dow Chemical Company), LUPOLEN™ (available from LyondellBasell), as well as HDPE products from Borealis, Ineos, and ExxonMobil.

The term “linear low density polyethylene,” (or “LLDPE”) as used herein, refers to a linear ethylene/α-olefin copolymer containing heterogeneous short-chain branching distribution comprising units derived from ethylene and units derived from at least one C₃-C₁₀ α-olefin, or C₄-C₈ α-olefin comonomer. LLDPE is characterized by little, if any, long chain branching, in contrast to conventional LDPE. LLDPE has a density from 0.910 g/cc to less than 0.940 g/cc. Nonlimiting examples of LLDPE include TUFLIN™ linear low density polyethylene resins (available from The Dow Chemical Company), DOWLEX™ polyethylene resins (available from the Dow Chemical Company), and MARLEX™ polyethylene (available from Chevron Phillips).

The term “low density polyethylene” (or “LDPE”) may also be referred to as “high pressure ethylene polymer” or “highly branched polyethylene” and is an ethylene homopolymer and is typically produced by way of high pressure free radical polymerization ((≥100 MPa (for example, 100-400 MPa), tubular reactor or autoclave reactor with free radical initiator). LDPE resins typically have a density in the range of 0.915 to less than 0.940 g/cc. LDPE is distinct from LLDPE.

An “olefin-based polymer,” or “polyolefin,” as used herein is a polymer that contains more than 50 mole percent polymerized olefin monomer (based on total amount of polymerizable monomers), and optionally, may contain at least one comonomer. Nonlimiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

### Test Methods

Compression molded specimens are formed at 180° C. and 10 MPa molding pressure for 5 minutes and then quenched between chilled platens (15° C. . . . 20° C.) for 2 minutes, or as otherwise described herein.

Compression Set (C-set) Measurements. The compression sets were measured following ASTM method 395, Method B, with following conditions: ~0.5 inch (t_{original}) thickness disc with 1 inch diameter from compression set was press to 0.375 inch thickness and was aged at temperature 70 and 100° C. for 20 hrs; after that the sample was released and allowed to sit at room temperature for 30 minutes, and then the thickness was remeasured to be t_{final}. The compression set (C-set) was calculated with following equations: C-set=(t_{original}−t_{final})/(t_{original}−0.375)*100%. The reported C-set was an average from 3 repeated measurements.

Density is measured in accordance with ASTM D792 with results reported in g/cc at 25° C.

Dynamic mechanical analysis (DMA). DMA experiments are conducted using a TA Instruments RSA-G2 Solid Analyzer to measure the storage modulus (G′), loss modulus (G″), and damping ratio (tan δ) of networks as a function of temperature and recycling under a nitrogen atmosphere. DMA is operated in tension mode at a frequency of 1 Hz with a 0.03% oscillatory strain. Data is collected from room temperature to 160° C. with a heating rate of 3° C./minute.

Heat distortion temperature (HDT) is measured using ASTMD648 method. The temperature at which the sample deforms is reported for 0.455 MPa and 1.82 MPa load.

Melt index (MI or I₂) (for ethylene-based polymers) is measured in accordance with ASTM D 1238, Condition 190° C./2.16 kg with results reported in grams per 10 minutes (g/10 min). I₂₁ is measured in accordance with ASTM D 1238, Condition 190° C./21.6 kg with results reported in grams per 10 minutes (g/10 min).

Rheology analysis was performed using a Rubber Process Analyzer (RPA). Rheology of the compositions was measured using a rotorless oscillating shear rheometer, Alpha Technologies RPA 2000 instrument, according to ASTM D6204, under the following test conditions and exceptions. The sample was placed between two pieces of Mylar film for analysis. Rheology was monitored during an initial timed test at 180° C., 1.0 rad/s, 7% strain, for 60 min. Elastic torque, S′, at the end of the 60 minutes (min) crosslinking step was recorded. Immediately following the 60 min at 160° C., a frequency sweep from 0.1 to 300 rad/s was conducted at 180° C., 7% strain on the same sample, followed by a frequency sweep from 0.1 to 300 rad/s at 190° C., 7% strain, and followed by a frequency sweep from 0.1 to 300 rad/s at 230° C., 7% strain. The dynamic complex viscosity, n*, and tan delta were recorded for each frequency sweep. In ASTM D6204, frequency sweeps on unvulcanized rubber are conducted prior to a cure step. In this case, frequency sweeps were conducted after the initial crosslinking step at 180° C. to evaluate the reversibility of the crosslinking. The viscosity temperature reprocessing ratio (or “VRR”) is defined as follows:
VRR is the ratio of n* at 0.1 rad/s, 180° C. to n* at 0.1 rad/s, 230° C.

Tensile Measurements @ 80° C. The tensile measurements were performed according to ASTM D1708 standards, at a 1 inch/min extension speed on an INSTRON equipment. The tensile bars were prepared by die cutting from the compression molded sheet with thickness of 1.5 mm. The testing was performed in an environmental chamber with temperature equilibrated at 80° C. for 30 min before testing. Here, the tensile strength was recorded to reflecting whether the materials has crosslinked properties, which is the maximum stress applied before the breaking of the samples. These parameters were averaged by 3 repeated tensile measurements. Compared to a non-crosslinked part, a crosslinked part typically has a significantly higher tensile strength at break.

Thermal Mechanical Analysis (Penetration Temperature) is conducted on a 30 mm diameter×3.3 mm thick, compression molded discs, formed at 180° C. and 10 MPa molding pressure for 5 minutes and then air quenched. The instrument used is a TA Instruments, TMA400, Thermomechanical Analyzer. In the test, a 1.5 mm probe is applied to the surface of the sample disc with a 1N force. The temperature is raised at 5° C./min from 25° C. The probe penetration is measured as a function of temperature. The experiment ends when the probe has penetrated at 1000 mm (1 mm) into the sample.

Vicat softening point is measured using ASTMD1525. The temperature is reported at which a flat-pointed needle penetrates the sample to a thickness of 1 mm when loaded at 10 N.

### DETAILED DESCRIPTION

The present disclosure provides a process. In an embodiment, the process includes feeding components into a mixing device. The components include (i) a (polar) ethylene-based polymer having a melt temperature, Tm, (ii) a free radical initiator having a decomposition temperature, T_{decomp}, and (iii) 2,2,6,6-tetramethyl-4-piperidyl methacrylate disulfide (BiTEMPS methacrylate). The process includes mixing, in the mixing device, components (i), (ii), and (iii) at a temperature less than the decomposition temperature of the free radical initiator. The process includes forming a crosslinkable polymer composition comprising the (polar) ethylene-based polymer the BiTEMPS methacrylate, and the free radical initiator.

### A. (Polar) Ethylene-Based Polymer

The components include a (polar) ethylene-based polymer. A “(polar) ethylene-based polymer,” as used herein, is (i) a polar ethylene-based polymer, (ii) an ethylene-based polymer, or (iii) a combination of (i) and (ii). A “polar ethylene-based polymer,” as used herein, is an ethylene-based polymer composed of (i) ethylene monomer, (ii) a comonomer that contains a heteroatom, and (iii) an optional termonomer (that may or may not contain a heteroatom). Stated differently, the polar ethylene-based polymer is not a hydrocarbon. The polar ethylene-based polymer has a melt index (MI) from 0.1 g/10 min to 100 g/10 min, or from 1 g/10 min to 100 g/10 min, or from 1 g/10 min to 50 g/10 min, or from 1 g/10 min to 25 g/10 min, or from 1 g/10 min to 10 g/10 min, or from 1 g/10 min to 5 g/10 min. Nonlimiting examples of comonomers with a heteroatom include carbon monoxide, carboxylic acids, esters, alkyl acrylates having 1 to 30 carbon atoms, methacrylate esters having 1 to 30 carbon atoms, vinyl siloxanes having 1 to 16 carbon atoms and halogens. Nonlimiting examples of suitable polar ethylene-based polymer include ethylene/carboxylic acid copolymer and metal-salt partially neutralized ionomers derived thereof, ethylene/acrylic acid copolymer (EAA), ethylene/methacrylic acid copolymer (EMAA), ethylene/vinyl(trimethoxy)silane copolymer (EVTMS), ethylene/vinyl acetate copolymer (EVA), ethylene/methyl acrylate (EMA), ethylene/ethyl acrylate copolymer (EEA), ethylene/butyl acrylate copolymer (EBA), ethylene/carbon monoxide (ECO), ethylene/glycidyl methacrylate (E/GMA), ethylene/methyl methacrylate copolymer, ethylene/butyl methacrylate copolymer, ethylene/stearylacrylate copolymer, ethylene/stearylmethacrylate copolymer, ethylene/octylacrylate copolymer, ethylene/2-ethylhexylacrylate copolymer, ethylene/dodecylacrylate copolymer, polyvinyldichloride (PVCD), ethylene/maleic anhydride copolymer (EMAH), polyvinylchloride (PVC), and combinations thereof. Additional nonlimiting terpolymer examples include ethylene/carboxylic acid/acrylate terpolymers and metal-salt partially neutralized ionomers derived thereof, ethylene/methyl acrylate/vinyl(trimethoxy)silane terpolymer copolymer (EMAVTMS), ethylene/ethyl acrylate/vinyl(trimethoxy)silane terpolymer copolymer (EEAVTMS), ethylene/butyl acrylate/vinyl(trimethoxy)silane terpolymer copolymer (EBAVTMS), ethylene/methyl acrylate/glycidyl methacrylate (EMAGMA) ethylene/butyl acrylate/glycidyl methacrylate (EBAGMA), ethylene/vinyl acetate/maleic anhydride terpolymer (EEAMAH), ethylene ethyl acrylate/maleic anhydride (EEAMAH) terpolymer, and combinations thereof.

In an embodiment, the polar ethylene-based polymer is an ethylene/vinyl acetate copolymer.

The (polar) ethylene-based polymer can be an ethylene-based polymer. An “ethylene-based polymer,” as used herein, is a hydrocarbon and therefore is distinct from the polar ethylene-based polar which contains a heteroatom. The ethylene-based polymer can be an ethylene homopolymer, an ethylene/α-olefin interpolymer, or an ethylene/C₄-C₂₀ α-olefin copolymer. In embodiments herein, the ethylene-based comprises greater than 50 wt. % of the units derived from ethylene and less than 30 wt. % of the units derived from one or more α-olefin comonomers (based on the total amount of polymerizable monomers). All individual values and subranges of greater than 50 wt. % of the units derived from ethylene and less than 30 wt. % of the units derived from one or more α-olefin comonomers. Suitable α-olefin comonomers typically have no more than 20 carbon atoms. For example, the α-olefin comonomers may have 3 to 10 carbon atoms, or 3 to 8 carbon atoms. Exemplary α-olefin comonomers include, but are not limited to, propylene, 1-butene, 1-pentene, 1-hexene, 1-heptene, 1-octene, 1-nonene, 1-decene, and 4-methyl-1-pentene. The one or more α-olefin comonomers may, for example, be selected from the group consisting of propylene, 1-butene, 1-hexene, and 1-octene; or in the alternative, from the group consisting of 1-butene, 1-hexene and 1-octene, or in the alternative, from the group consisting of 1-hexene and 1-octene. In some embodiments, the ethylene-based polymer comprises greater than 0 wt. % and less than 30 wt. % of units derived from one or more of 1-octene, 1-hexene, or 1-butene comonomers.

The ethylene-based polymer has a melt index (MI) from 0.1 g/10 min to 100 g/10 min, or from 1 g/10 min to 100 g/10 min, or from 1 g/10 min to 50 g/10 min, or from 1 g/10 min to 25 g/10 min, or from 1 g/10 min to 10 g/10 min, or from 1 g/10 min to 5 g/10 min. In embodiments herein, the ethylene-based polymer has a density in the range of 0.854 to 0.925 g/cc. All individual values and subranges of 0.854 to 0.925 g/cc are included and disclosed herein. In some embodiments, the ethylene-based composition may have a density of 0.895 to 0.925 g/cc, 0.900 to 0.925 g/cc, 0.900 to 0.920 g/cc, 0.900 to 0.915 g/cc, 0.900 to 0.912 g/cc, 0.900 to 0.911 g/cc, or 0.900 to 0.910 g/cc. In further specific embodiments, the ethylene-based polymer composition may have a density of 0.875 to 0.925 g/cc, 0.890 to 0.925 g/cc, 0.900 to 0.925 g/cc, 0.903 to 0.925 g/cc, or 0.905 to 0.925 g/cc. Density may be measured in accordance with ASTM D792.

Nonlimiting examples of suitable ethylene-based polymer include ethylene/α-olefin interpolymers, high density polyethylene (HDPE), linear low density polyethylene (LLDPE), low density polyethylene (LDPE), and combinations thereof.

In an embodiment, the ethylene/α-olefin interpolymer is an ethylene/C₄-C₈ α-olefin copolymer having one, some, or all of the following properties:
(i) an octene comonomer; and/or
(ii) a density from 0.860 g/cc to 0.925 g/cc, or from 0.880 g/cc to 0.920 g/cc, or from 0.899 g/cc to 0.915 g/cc, or from 0.899 g/cc to 0.910 g/cc; and/or
(iii) a melt index from 0.5 g/10 min to 100 g/10 min, or from 1 g/10 min to 30 g/10 min, or from 2 g/10 min to 20 g/10 min. Nonlimiting examples of suitable ethylene/C₄-C₈ α-olefin copolymers include ENGAGE™ 8450 POE, ENGAGE™ 8402 POE, ENGAGE™ 8401 POE, ELITE™ 5815 Enhanced Polyethylene Resin, ELITE™ 5220 Enhanced Polyethylene Resin, or blends thereof.

In an embodiment, the ethylene-based polymer is an ethylene/α-olefin multi-block copolymer. The term “ethylene/α-olefin multi-block copolymer” refers to an ethylene/C₃-C₈ α-olefin multi-block copolymer consisting of ethylene and one copolymerizable C₃-C₈ α-olefin comonomer, or C₄-C₈ α-olefin comonomer, in polymerized form (and optional additives), the polymer characterized by multiple blocks or segments of two polymerized monomer units differing in chemical or physical properties, the blocks joined (or covalently bonded) in a linear manner, that is, a polymer comprising chemically differentiated units which are joined end-to-end with respect to polymerized ethylenic functionality. Ethylene/α-olefin multi-block copolymer includes block copolymer with two blocks (di-block) and more than two blocks (multi-block). The C₃-C₈ α-olefin is selected from propylene, butene, hexene, and octene. The ethylene/α-olefin multi-block copolymer is void of, or otherwise excludes, styrene (i.e., is styrene-free), and/or vinyl aromatic monomer, and/or conjugated diene. When referring to amounts of “ethylene” or “comonomer” in the copolymer, it is understood that this refers to polymerized units thereof. In some embodiments, the ethylene/α-olefin multi-block copolymer can be represented by the following formula: (AB)ₙ; where n is at least 1, preferably an integer greater than 1, such as 2, 3, 4, 5, 10, 15, 20, 30, 40, 50, 60, 70, 80, 90, 100, or higher, “A” represents a hard block or segment, and “B” represents a soft block or segment. The As and Bs are linked, or covalently bonded, in a substantially linear fashion, or in a linear manner, as opposed to a substantially branched or substantially star-shaped fashion. In other embodiments, A blocks and B blocks are randomly distributed along the polymer chain. In other words, the block copolymers usually do not have a structure as follows: AAA-AA-BBB-BB. In an embodiment, the ethylene/α-olefin multi-block copolymer does not have a third type of block, which comprises different comonomer(s). In another embodiment, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

In an embodiment, ethylene comprises the majority mole fraction of the whole ethylene/α-olefin multi-block copolymer, i.e., ethylene comprises at least 50 wt % of the whole ethylene/α-olefin multi-block copolymer. More preferably, ethylene comprises at least 60 wt %, at least 70 wt %, or at least 80 wt %, with the substantial remainder of the whole ethylene/α-olefin multi-block copolymer comprising the C₃-C₈ α-olefin comonomer, or C₄-C₈ α-olefin comonomer. In an embodiment, the ethylene/α-olefin multi-block copolymer contains 50 wt % to 90 wt % ethylene, or 60 wt % to 85 wt % ethylene, or 65 wt % to 80 wt % ethylene.

The ethylene/α-olefin multi-block copolymer includes various amounts of “hard” segments and “soft” segments. “Hard” segments are blocks of polymerized units in which ethylene is present in an amount greater than 90 wt %, or 95 wt %, or greater than 95 wt %, or greater than 98 wt %, based on the weight of the polymer, up to 100 wt %. In other words, the comonomer content (content of monomers other than ethylene) in the hard segments is less than 10 wt %, or 5 wt %, or less than 5 wt %, or less than 2 wt %, based on the weight of the polymer, and can be as low as zero. In some embodiments, the hard segments include all, or substantially all, units derived from ethylene. “Soft” segments are blocks of polymerized units in which the comonomer content (content of monomers other than ethylene) is greater than 5 wt %, or greater than 8 wt %, greater than 10 wt %, or greater than 15 wt %, based on the weight of the polymer. In an embodiment, the comonomer content in the soft segments is greater than 20 wt %, greater than 25 wt %, greater than 30 wt %, greater than 35 wt %, greater than 40 wt %, greater than 45 wt %, greater than 50 wt %, or greater than 60 wt % and can be up to 100 wt %.

The soft segments can be present in an ethylene/α-olefin multi-block copolymer from 1 wt % to 99 wt % of the total weight of the ethylene/α-olefin multi-block copolymer, or from 5 wt % to 95 wt %, from 10 wt % to 90 wt %, from 15 wt % to 85 wt %, from 20 wt % to 80 wt %, from 25 wt % to 75 wt %, from 30 wt % to 70 wt %, from 35 wt % to 65 wt %, from 40 wt % to 60 wt %, or from 45 wt % to 55 wt % of the total weight of the ethylene/α-olefin multi-block copolymer. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, entitled “Ethylene/α-Olefin Block Inter-Polymers,” filed on Mar. 15, 2006, in the name of Colin L. P. Shan, Lonnie Hazlitt, et. al. and assigned to Dow Global Technologies Inc., the disclosure of which is incorporated by reference herein in its entirety. In particular, hard and soft segment weight percentages and comonomer content may be determined as described in column 57 to column 63 of U.S. Pat. No. 7,608,668.

In addition, the ethylene/α-olefin multi-block copolymer possesses a PDI (or Mw/Mn) fitting a Schultz-Flory distribution rather than a Poisson distribution. The present ethylene/α-olefin multi-block copolymer has both a polydisperse block distribution as well as a polydisperse distribution of block sizes. This results in the formation of polymer products having improved and distinguishable physical properties. The theoretical benefits of a polydisperse block distribution have been previously modeled and discussed in Potemkin, Physical Review E (1998) 57 (6), pp. 6902-6912, and Dobrynin, J. Chem. Phys. (1997) 107 (21), pp 9234-9238.

In an embodiment, the present ethylene/α-olefin multi-block copolymer possesses a most probable distribution of block lengths.

In an embodiment, the ethylene/α-olefin multi-block copolymer is an ethylene/1-octene multi-block copolymer (consisting only of ethylene and octene comonomer) and has one, some, or all of the following properties:
(i) a Mw/Mn from 1.7, or 1.8 to 2.2, or 2.5, or 3.5; and/or
(ii) a density from 0.860 g/cc, or 0.865 g/cc, to 0.870 g/cc, or 0.877 g/cc, or 0.880 g/cc; and/or
(iii) a melting point, Tm, from 115° C., or 118° C., or 119° C., or 120° C. to 120° C., or 123° C., or 125° C.; and/or
(iv) a melt index (MI) from 0.1 g/10 min, or 0.5 g/10 min to 1.0 g/10 min, or 2.0 g/10 min, or 5 g/10 min, or 10 g/10 min; and/or
(v) from 50 to 85 wt % soft segment and from 50 to 15 wt % hard segment (based on total weight of the ethylene/octene multi-block copolymer); and/or
(vi) from 10 mol %, or 13 mol %, or 14 mol %, or 15 mol % to 16 mol %, or 17 mol %, or 18 mol %, or 19 mol %, or 20 mol % octene in the soft segment; and/or
(vii) from 0.5 mol %, or 1.0 mol %, or 2.0 mol %, or 3.0 mol % to 4.0 mol %, or 5 mol %, or 6 mol %, or 7 mol %, or 9 mol % octene in the hard segment; and/or
(viii) an elastic recovery (Re) from 50%, or 60% to 70%, or 80%, or 90%, at 300% min 1 deformation rate at 21° C. as measured in accordance with ASTM D 1708; and/or
(ix) a polydisperse distribution of blocks and a polydisperse distribution of block sizes (hereafter referred to as multi-block copolymer properties (i)-(ix)).

In an embodiment, the ethylene/α-olefin multi-block copolymer is an ethylene/octene multi-block copolymer. The ethylene/octene multi-block copolymer is sold under the tradename INFUSE™ Olefin Block Copolymer, available from The Dow Chemical Company, Midland, Michigan, USA.

The ethylene/α-olefin multi-block copolymer can be produced via a chain shuttling process such as described in U.S. Pat. No. 7,858,706, which is herein incorporated by reference. In particular, suitable chain shuttling agents and related information are listed in col. 16 line 39 through col. 19 line 44. Suitable catalysts are described in col. 19 line 45 through col. 46 line 19 and suitable co-catalysts in col. 46 line 20 through col. 51 line 28. The process is described throughout the document, but particularly in col. 51 line 29 through col. 54 line 56. The process is also described, for example, in the following: U.S. Pat. Nos. 7,608,668; 7,893,166; and 7,947,793.

### B. Free Radical Initiator

The components include a free radical initiator. In an embodiment, the free radical initiator is an organic peroxide. Nonlimiting examples of suitable organic peroxide include bis(1,1-dimethylethyl) peroxide; bis(1,1-dimethylpropyl) peroxide; 2,5-dimethyl-2,5-bis(1,1-dimethylethylperoxy) hexane; 2,5-dimethyl-2,5-bis(1,1-dimethylethylperoxy) hexyne; 4,4-bis(1,1-dimethylethylperoxy) valeric acid; butyl ester; 1,1-bis(1,1-dimethylethylperoxy)-3,3,5-trimethylcyclohexane; benzoyl peroxide; tert-butyl peroxybenzoate; di-tert-amyl peroxide (“DTAP”); bis(α-t-butyl-peroxyisopropyl)benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3,1,1-bis(t-butylperoxy)-3,3,5-trimethylcyclohexane; isopropylcumyl cumylperoxide; butyl 4,4-di(tert-butylperoxy) valerate; di(isopropylcumyl) peroxide; dicumyl peroxide, and combinations thereof.

In an embodiment the free radical initiator is dicumyl peroxide.

### C. BiTEMPS Methacrylate Disulfide

The components include 2,2,6,6-tetramethyl-4-piperidyl methacrylate disulfide, interchangeably referred to as “BiTEMPS methacrylate,” or “BiTEMPS” or “BIT.” BiTEMPS methacrylate disulfide has the Structure 1 below.

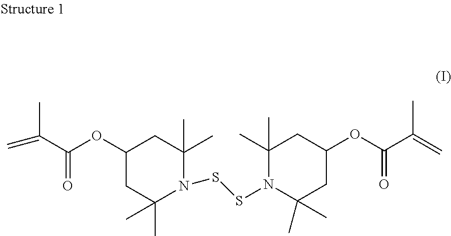 [SMILES: C=C(C)C(=O)OC1CC(C)(C)N(SSN2C(C)(C)CC(OC(=O)C(=C)C)CC2(C)C)C(C)(C)C1]

### D. Blend Component

In an embodiment, the components include a blend component. Nonlimiting examples of suitable blend component include polyolefins (e.g., polyethylene other than the ethylene-based polymer crosslinked with BiTEMPS methacrylate and polypropylene), polymers (e.g., polystyrene, ABS, SBS and the like) and combinations thereof. Non-limiting examples of suitable polyolefins include polyethylene; polypropylene; polybutylene (e.g., polybutene-1); polypentene-1; polyhexene-1; polyoctene-1; polydecene-1; poly-3-methylbutene-1; poly-4-methylpentene-I; polyisoprene; polybutadiene; poly-1,5-hexadiene; interpolymers derived from olefins; interpolymers derived from olefins and other polymers such as polyvinyl chloride, polystyrene, polyurethane, and the like; and mixtures thereof.

### E. Additives

The components may include one or more optional additives. Nonlimiting examples of suitable additives include grafting initiators, cross-linking catalysts, blowing agent, blowing agent activators (e.g., zinc oxide, zinc stearate and the like), coagents (e.g., triallyl cyanurate), plasticizers, processing oils, processing aids, carbon black, colorants or pigments, stability control agents, nucleating agents, fillers, antioxidants, acid scavengers, ultraviolet (UV) stabilizers, flame retardants, lubricants, processing aids, extrusion aids, and combinations thereof. When present, the total amount of additive can be from greater than 0 to 80%, or from 0.001% to 70%, or from 0.01% to 60%, or from 0.1% to 50%, or from 0.1% to 40%, or from 0.1% to 20%, or from 0.1% to 10%, or from 0.1% to 5% of the total weight of the composition.

### F. Mixing

The components (i) the (polar) ethylene-based polymer, (ii) the free radical initiator (peroxide) and (iii) the BiTEMPS, (and optional additives) are mixed in a mixing device. In an embodiment, the components form a mixture and the mixture includes
from 70 wt % to 98.5 wt %, or from 77 wt % to 98.5 wt % of the (polar) ethylene-based polymer;
from 0.1 wt % to 10 wt %, or from 0.1 wt % to 5 wt % 0.1 wt % to 3.0 wt % or from 0.1 wt % to 1.5 wt %, or from 0.5 wt % to 1.5 wt % free radical initiator that is an organic peroxide (such as dicumyl peroxide for example); and
   from 1 wt % to 20 wt %, or from 1 wt % to 15 wt %, or from 2 wt % to 20 wt %, or from 2 wt % to 10 wt % BiTEMPS methacrylate disulfide. It is understood that the aggregate of the (polar) ethylene-based polymer, the free radical initiator, and the BiTEMPS methacrylate disulfide (and optional additives) amount to 100 wt % of the mixture.

The process includes mixing, in the mixing device, the components (i), (ii), and (iii) (and optional additives) at a temperature less than the decomposition of the free radical initiator (peroxide) to form the crosslinkable polymer composition. The crosslinkable polymer composition includes (i) the (polar) ethylene-based polymer, (ii) the free radical initiator (peroxide) and (iii) the BiTEMPS, (and optional additives). The process ensures that the mixing temperature (and/or the act of mixing) does not initiate (i.e., does no “kick-off”) the free radical initiator. In this way, the formant crosslinkable polymer composition contains no, or is otherwise void of, (i) crosslinking, (ii) grafting, and/or (iii) void of a combination of (i) and (ii). In other words, the crosslinkable polymer composition has a gel content of 0%, or substantially 0%.

In an embodiment, the crosslinkable polymer composition is produced in a post reactor step using an extruder. The extruder can be a single screw extruder, multiple screw extruder with positive and negative conveyance screw elements, and lobed kneading/mixing plates, paddles or blocks.

In an embodiment, the process includes mixing at a temperature from greater than or equal to the melt temperature of the (polar) ethylene-based polymer to less than the decomposition temperature of the free radical initiator.

In an embodiment, the free radical initiator is dicumyl peroxide and the process includes mixing at a temperature less than 140° C., or mixing a temperature from 30° C. to less than 140° C., or from 40° C. to less than 140° C., or from 50° C. to less than 140° C., or from 60° C. to less than 140° C., or from 70° C. to less than 140° C., or from 80° C. to less than 140° C., or from 90° C. to less than 140° C., or from 100° C. to less than 140° C. In an embodiment, the mixing includes
(A) melt blending the (polar) ethylene-based polymer at a first temperature for a first process period;
(B) adding the BiTEMPS and free radical initiator over a second process period to the melt blended ethylene-based polymer of step (A) to form the mixture;
(C) blending the mixture; and
(D) forming the crosslinkable polymer composition.

The (polar) ethylene-based polymer is melt-blended in the first period. In an embodiment, the first temperature of process step (A) is a temperature±50° C., or ±40° C., or ±30° C., or ±20° C. of the Tₘ of the (polar) ethylene-based polymer. The first temperature is sufficient to result in the complete, or substantially complete, melting of the (polar) ethylene-based polymer. The first temperature is less than the decomposition temperature of the free radical initiator.

In an embodiment, the free radical initiator is dicumyl peroxide and the first temperature is a temperature from 60° C. to less than 140° C., or from 80° C. to less than 140° C., or from 85° C. to 135° C., or from 85° C. to 130° C., or from 90° C. to 120° C. In a further embodiment, the first temperature is a temperature greater than or equal to the Tₘ of the (polar) ethylene-based polymer to less than the T_{decomp} of the free radical initiator.

In the second period the BiTEMPS and free radical initiator are added and mixed into the melted (polar) ethylene-based polymer. In an embodiment, the first process period ends before the second process period begins.

In step (C), the mixing temperature remains below the decomposition temperature of the free radical initiator. The free radical initiator does not initiate (i.e., does not “kick-off”).

In an embodiment, steps (A)-(D) are performed in an extruder. Alternatively, steps (A)-(D) are performed in a batch mixing device, such as a Haake™ mixing device. The process forms (D) the crosslinkable polymer composition.

In an embodiment the process includes collecting the crosslinkable polymer composition. The crosslinkable polymer composition can be collected, or otherwise formed, as a plurality of pellets, as one or more bales, or as a combination of pellets and bales.

The extruder can operate at a rate of production sufficient to produce greater than or equal to 2,000 lbs. of crosslinkable polymer composition per hour, or greater than or equal to 2,100 lbs. of crosslinkable polymer composition per hour, or greater than or equal to 2,200 lbs. of crosslinkable polymer composition per hour.

The screw speed can be from 200 rpm to 900 rpm. The screw speed is adjusted based on the torque and melt temperature developed. The barrel temperatures in the reaction zone of the extruder can be between 60° C. and less than 140° C.

### G. Crosslinking

In an embodiment, the process includes heating the crosslinkable polymer composition to a crosslinking temperature from 160° C. to less than 199° C., or from 180° C. to less than 199° C., shaping at the crosslinking temperature, crosslinkable polymer composition into a pre-form; cooling the pre-form to below the crosslinking temperature; and forming a crosslinked article. In a further embodiment, the crosslinked article includes (i) the (polar) ethylene-based polymer and linkages having a Structure 2 formed from the 2,2,6,6-tetramethyl-4-piperidyl methacrylate disulfide (BiTEMPS methacrylate). The crosslinked article contains disulfide linkages formed from the BiTEMPS methacrylate by way of the crosslinking reaction, the disulfide linkages having the Structure 2 below.

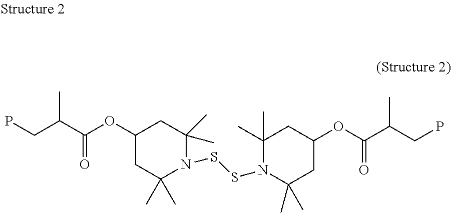

The term (and structure) “P” in Structure 2 above refers to the chain of polymerized (polar) ethylene (and optional comonomer(s)) for the (polar) ethylene-based polymer. The ethylene-based polymer of the crosslinked composition can be any ethylene-based polymer with a MI from 0.1 g/10 min to 100 g/10 min as previously disclosed herein.

In an embodiment, the shaping step is a procedure selected from the group consisting of injection molding, extrusion molding, thermoforming, slushmolding, over molding, insert molding, blow molding, cast molding, tentering, compression molding, and combinations thereof.

Nonlimiting examples of suitable articles for the crosslinked (polar) ethylene-based polymer composition (with linkages of Structure 2 formed from BiTEMPS methacrylate) include elastic film; elastic fiber; soft touch good, such as tooth brush handles and appliance handles; gaskets and profiles; adhesives (including hot melt adhesives and pressure sensitive adhesives); footwear (including shoe soles and shoe liners); auto interior parts and profiles; foam articles (both open cell foam and closed cell foam); impact modifiers for other thermoplastic polymers such as high density polyethylene, isotactic polypropylene, or other olefin polymers; coated fabrics; hoses; tubing; weather stripping; cap liners; flooring; and combinations thereof.

### H. Reprocess

BiTEMPS methacrylate is a “dynamic crosslinker.” The dynamic crosslinker BiTEMPS methacrylate enables formation of a crosslinked network of the ethylene-based polymer by way of disulfide linkages between the chains of the ethylene-based polymer. The crosslinked network is formed by the ethylene-based polymer and BiTEMPS methacrylate in the presence of the free radical initiator to form the crosslinked ethylene-based polymer composition. The crosslinking is dynamic because the disulfide linkages may be broken, allowing for chain mobility and exchange when the crosslinked ethylene-based polymer composition is subjected to a “reprocessing temperature,” the reprocessing temperature being a temperature from 160° C. to 230° C., or from 160° C. to 200° C. At the reprocessing temperature, the disulfide linkages in the crosslinked ethylene-based polymer composition are broken, forming a reprocessable ethylene-based polymer composition. Cooling the reprocessable ethylene-based composition below the reprocessing temperature forms a re-crosslinked ethylene-based polymer composition.

The dynamic crosslinker BiTEMPS methacrylate enables a cyclic “reprocessing” for fabrication of new polymeric articles. When the crosslinked ethylene-based polymer composition is heated to the reprocessing temperature, the disulfide linkages break, or otherwise cleave, enabling the previously-crosslinked ethylene-based polymer composition to flow at the reprocessing temperature, forming “a reprocessable ethylene-based polymer composition.” Heating to the reprocessing temperature enables link breaking and polymer chain flow, allowing the ethylene-based composition to be reshaped readily. At the reprocessing temperature, the reprocessable ethylene-based polymer composition is no longer crosslinked, but rather is flowable, enabling shaping and/or fabrication of the now flowable re-processable ethylene-based composition (with BiTEMPS methacrylate) into a new pre-form or article. Upon cooling to below the “reprocessing temperature,” the disulfide linkages form again, the network is re-established, and the re-crosslinked ethylene-based compositions is formed in the new article configuration with a return to the high viscosity (no flow at room temperature) and resistance to mechanical deformation indicative of the crosslinked network. When the newly-formed article of the reprocessable ethylene-based polymer composition is cooled below the reprocessing temperature, the disulfide linkages in the reprocessable ethylene-based polymer composition are re-established, and the ethylene-based polymer (with BiTEMPS methacrylate) becomes a re-crosslinked ethylene-based polymer composition in the shape of the newly-fabricated article. Below the reprocessing temperature, the network disulfide linkages are stable, and the re-crosslinked ethylene-based polymer composition exhibits the high viscosity and resistance to mechanical deformation indicative of a crosslinked network. This cycle of crosslink/reprocess/re-crosslink into a new article can be repeated.

Bounded by no particular theory, the number of “reprocessing” cycles that are possible with the present crosslinked ethylene-based composition (before competitive thermal and oxidative permanent crosslinking occurs and prevents further reprocessing), can be determined by calculating the ratio of the melt viscosity of the crosslinked ethylene-based polymer composition before and after a reprocessing cycle. For the crosslinked ethylene-based polymer composition to be re-processable, the ratio of the viscosity after reprocessing to the viscosity before reprocessing is from 0.5 to 5, or from 0.7 to 3 or from 0.9 to 2 or from 0.95 to 1.2.

Other metrics for monitoring the number of “reprocessing” cycles that are possible with the BiTEMPS methacrylate dynamic crosslinker before competitive oxidative permanent crosslinking occurs include visual observation. Formed film that is mechanically deformed is heated to the reprocessing temperature and is visually inspected to determine whether the mechanically deformed film heals to form a stable film.

In an embodiment, the process includes grinding the crosslinked article to form a grind material and heating the grind material to a reprocessing temperature from 180° C. to 199° C. The process includes forming, at the reprocessing temperature, the regrind material into a re-processable (polar) ethylene-based polymer composition, and shaping, at the reprocessing temperature, the re-processable (polar) ethylene-based polymer composition into a re-processed pre-form. The process includes cooling the re-processed pre-form to below the reprocessing temperature; and forming a reprocessed crosslinked article.

The reprocessed crosslinked article contains disulfide linkages formed from the BiTEMPS methacrylate by way of the re-crosslinking reaction, the disulfide linkages having the Structure 2 below.

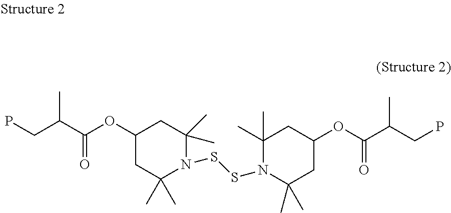

Suitable articles for the re-processed (polar) ethylene-based polymer composition (with linkages of Structure 2 formed from BiTEMPS methacrylate) include elastic film; elastic fiber; soft touch good, such as tooth brush handles and appliance handles; gaskets and profiles; adhesives (including hot melt adhesives and pressure sensitive adhesives); footwear (including shoe soles and shoe liners); auto interior parts and profiles; foam articles (both open cell foam and closed cell foam); impact modifiers for other thermoplastic polymers such as high density polyethylene, isotactic polypropylene, or other olefin polymers; coated fabrics; hoses; tubing; weather stripping; cap liners; flooring; and combinations thereof.

In an embodiment, the process includes heating the crosslinked article to a reprocessing temperature from 200° C. to less than 250° C., or from 200° C. to 230° C. and forming, at the reprocessing temperature, the crosslinked article into a re-processable (polar) ethylene-based polymer composition. The process includes shaping, at the reprocessing temperature, the re-processable (polar) ethylene-based polymer composition into a re-processed pre-form, cooling the re-processed pre-form to below the reprocessing temperature, and forming a reprocessed thermoplastic article. The reprocessing temperature from 200° C. to less than 250° C. fully dissociates the disulfide linkages, thereby fully dissociating bonding between polymer chains in a non-reversible manner. The result is a thermoplastic material.

### 2. Materials

### 1. Materials

Materials used in the comparative samples (CS) and inventive examples (IE) are provided in Table 1 below.

| | | |
|---|---|---|
| ENGAGE ™ 8842 | Ethylene/octene random copolymer | The Dow Chemical |
| | d -0.857 g/cc, MI 1.0 g/10 min, Tm 38° C. | Company |
| ENGAGE ™ 8100 | Ethylene/octene random copolymer | The Dow Chemical |
| | Density = 0.870 g/cc, MI = 1 g/10 min, Tₘ = 60° C. | Company |
| INFUSE ™ 9000 | Ethylene/octene multi-block copolymer | The Dow Chemical |
| | d - 0.877 g/cc, MI - 0.5 g/10 min, Tm 120° C. | Company |
| ENGAGE ™ 8450 | Ethylene/octene random copolymer | The Dow Chemical |
| | d -0.902, g/cc, MI -3.0, g/10 min Tm 97° C. | Company |
| BiTEMPS methacrylate | 2,2,6,6-tetramethyl-4-piperidyl methacrylate disulfide (Structure 1) | Custom synthesis |
| crosslinker | C₂₆H₄₄N₂O₄S₂ | |
| Dicumyl Peroxide (“DCP”) | C₁₈H₂₂O₂ | Sigma-Aldrich |
| Radical initiator | Decomposition temperature: 133-143° C. | |

### 2. Synthesis of BiTEMPS Methacrylate

To synthesize BiTEMPS methacrylate, 2,2,6,6-tetramethyl-4-piperidyl methacrylate (8.78 g, 39.0 mmol, supplied by TCI America) is first dissolved in anhydrous petroleum ether (~90 mL, supplied by Sigma-Aldrich, dried over molecular sieves for 48 hr before use) and cooled to −70° C. in a dry ice/acetone bath. Afterward, sulfur monochloride (1.30 g, 9.7 mmol, supplied by Sigma-Aldrich) is dissolved in anhydrous petroleum ether (~1.25 mL) and added dropwise to the reaction vessel over the course of 30 minutes. The solution is stirred at −70° C. for an additional 30 minutes and at room temperature for 15 minutes. Next, BiTEMPS methacrylate is precipitated out by pouring the reaction solution into copious distilled water and stirring at room temperature overnight. The precipitates are collected, vacuum-filtered, and vacuum-dried at 60° C. for 48 hr to obtain BiTEMPS methacrylate, shown as Structure 1 below.

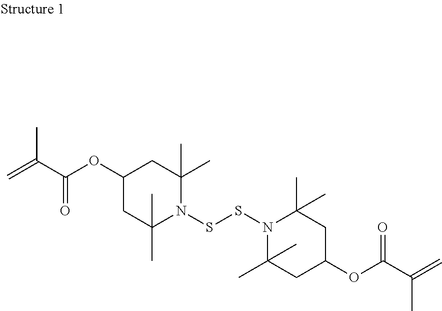

### 3. Preparation of Crosslinkable Composition (Process A)

Polymer compositions (weight parts) and process temperatures are listed in Table 2.

TABLE 2
Formulations and process of generating of crosslinkable BiTEMPS compositions.

| Label | IE 1 | IE 2 | IE 3 | IE 4 |
|---|---|---|---|---|
| Formulation Description | ENGAGE ™ 8842 | ENGAGE ™ 8100 | INFUSE ™ 9000 | ENGAGE ™ 8450 |
| | Blends | Blends | Blends | blends |
| ENGAGE ™ 8450 | | | | 100 |
| ENGAGE ™ 8842 | 100 | | | |
| ENGAGE ™ 8100 | | 100 | | |
| INFUSE ™ 9000 | | | 100 | |
| Dicumyl peroxide (DCP) | 1 | 1 | 1 | 1 |
| BITEMPS | 5 | 5 | 5 | 5 |
| Total (phr) | 106 | 106 | 106 | 106 |
| Density (g/cc) | 0.857 | 0.87 | 0.877 | 0.902 |
| Melt Index (dg/min) | 1 | 1 | 0.5 | 3 |
| Melting Temperature (° C.) | 38 | 60 | 122 | 97 |
| Process Claimed | Process A | Process A | Process A | Process A |
| Temperature (° C.) | 100 | 100 | 120 | 100 |
| Mixer Type | Haake Batch Mixer | Haake Batch Mixer | Haake Batch Mixer | Haake Batch Mixer |
| Outcome product | Formulated resin | Formulated resin | Formulated resin | Formulated resin |

For each composition in Table 2, the polymer pellets were melt blended with the peroxide and BiTEMPS methacrylate, at the given weight ratio, in an RSI RS5000, RHEOMIX™ 600 batch mixer (commonly referred to as a Haake™ Batch Mixer available from PolyLabs™) with CAM blades, at set temperature 30 RPM, for 10 minutes. As can be seen in Table the temperature in the Haake™ Batch mixer was carefully monitored to not exceed the 140° C. to avoid the unfavored reactions. Gel formation was observed if the temperature exceeded 140° C. which prevented further processing of the samples due to the increased torque in the Haake™ Batch mixer. It is believed that the gel formation is a result of the activation of the free radical initiator resulting in the crosslinking of the BiTEMPS with the ethylene-based polymer. At temperatures below 140° C. this activation was not observed.

After formulation, the crosslinkable polymer compositions containing ethylene-based polymer, BiTEMPS and free radical initiator (DCP) were cooled in a Carver press (cooled platens) at 20000 psi, for four minutes, to make a “crosslinkable pancakes” IE 1-4 for further testing.

### 4. Preparation of Crosslinked Compositions and Materials Characteristics

The crosslinkable pancakes were crosslinked by compression molding. For this process, the crosslinkable pancakes IE 1-4 were placed into a Carver molder with Model 4095, 60 Ton, Dual daylight openings size 12″×12″ heated/cooled platens, temperature range capabilities—20° C. to 260° C. The Carver molder is capable of making a 2 mm thick sheet, and 1 inch diameter and 0.5 inch thick button. For all of the samples, the compression molding was performed at 180° C. for 15 min at 3000 psi. The crosslinked samples were then cooled to 20° C. with a cold press at 3000 psi pressure to provide crosslinked plaques IE 7-9 were submitted for further physical testing to confirm crosslinking in the samples which are reported in Table 3 below.

TABLE 3
Crosslinked Properties of IE 1-4 Compositions.

| Label | IE 7 | IE 8 | IE 9 | IE 10 |
|---|---|---|---|---|
| Formed Parts | ENGAGE ™ 8842 | ENGAGE ™ 8100 | INFUSE ™ 9000 Blends | ENGAGE ™ 8450 |
| Description | Blends after molding | Blends after molding | after molding | Blends after molding |
| Molded Materials | IE 1 | IE 2 | IE 3 | IE 4 |
| Temperature (° C.) | 180 | 180 | 180 | 180 |
| Curing time (min) | 15 | 15 | 15 | 15 |
| Cset @ 70° C. | 70 | 87 | 34 | — |
| Cset @ 100° C. | — | 71 | — | — |
| DMS temperature | — | — | — | >0.2 |
| sweep - Torsion | | | | |
| modulus at 140° C. | | | | |
| (MPa) | | | | |
| Tensile strengh @ | 210 | — | — | — |
| 80° C. | | | | |
| RPA n*(0.1) @160° | 1816796 | 1442960 | 2640058 | — |
| C. | | | | |
| RPA n*(300) @160° | 1214 | — | 1527 | — |
| C. | | | | |
| RPA TD(0.1) @160° | 0.21 | 0.302 | 0.17 | — |
| C. | | | | |
| RPA n*(0.1) @230° | 219976 | 126725 | 416689 | — |
| C. | | | | |
| RPA n*(300) @230° | 526 | — | 763 | — |
| C. | | | | |
| RPA TD(0.1) @230° | 0.66 | 1.051 | 0.47 | — |
| C. | | | | |
| Viscosity | 8.26 | 11.38 | 6.34 | — |
| Temperature | | | | |
| Reprocessing Ratio | | | | |

### 4. Preparation Reprocessed Thermoplastic Article (Process C)

After being compression molded and chilled IE 8-10 from Table 3 were reprocessed under conditions such that thermoset materials wer reprocessed into a thermoplastic materials. Here, the crosslinked samples IE 8-10 were cut into strips and fed into a co-rotating twin-screw Xplore MC40 Micro Compounder, at 50 RPM and in the temperature range of 230° C. for six minutes. As comparison, sample (CS1) of crosslinked ENGAGE™ 8100 in the absence of BiTEMPS was also reprocessed on the Xplore MC40 Micro Compounder.

TABLE 4
Reprocessing of IE 8-10 into a thermoplastic material.

| Label | IE 11 | IE 12 | IE 14 | CS 1 |
|---|---|---|---|---|
| Recycled materials | ENGAGE ™ 8100 | INFUSE ™ 9000 Blends | ENGAGE ™ 8450 | ENGAGE ™ 8100 Blends |
| description | Blends after | after molding then | Blends after | after molding then |
| | molding then | recycled | molding then | recycled |
| | recycled | | recycled | |
| Recycle Materials | IE 8 | IE 9 | IE 10 | IE 8 |
| Equipment | Xplore MC 40 | Xplore MC 40 Micro- | Xplore MC 40 | Xplore MC 40 Micro- |
| | Micro-extruder | extruder | Micro-extruder | extruder |
| Extrusion Temperature | 200-230 | 200-230 | 200-230 | <200 |
| (° C.) | | | | |
| RPM | 50 | 50 | 50 | 25 |
| Torque (Nm) | 34.6 | 44.1 | | 43.3 |
| Melt Temperature (C.) | 222-228 | 203-207 | | 192-200 |
| Outcome of products | Devulcanized | Devulcanized rubber to | Devulcanized | Heavily fractured strand |
| | rubber to | thermoplastics resins, | rubber to | if temperature lower |
| | thermoplastics | and can be reused for | thermoplastics | than 200° C., and |
| | resins, and can | parts fabrication and | resins, and can be | potentially leading to |
| | be reused for | formulation | reused for parts | none qualified pellets |
| | parts fabrication | | fabrication and | |
| | and formulation | | formulation | |

Samples IE 11-14 were successfully extruded in a continuous manner. It was discovered that at temperatures greater than 250° C., side reactions were produced resulting in the degradation of the sample. Temperatures less than 200° C. resulted in high torque strain inhibiting extrusion. Thus at a sufficiently high temperature (from 200° C. to 230° C.) IE 11-14, can be extruded with typical polymer extrusion conditions. The strand from the extrusion has good quality and minor surface roughness, but the physical performance was found to be similar to a thermoplastic due to the irreversibly dissociated chemical bonding. The extruded strands for each sample IE 11-14 were collected and cooled on a surface of Teflon™ coated stainless steel plate.

It was discovered that Comparative Sample 1 (CS) which did not contain the BiTEMPS was not able to be reprocessed into a thermoplastic material. Specifically for CS1 high torque within the extruder was observed that at the temperature of 230° C. and the product was not extrudable. An extruded material was produced at temperatures of less than 200° C., however the extrudate was heavily fractured and therefore would not be a candidate for pelletization or subsequent reprocessing.

### 5. Process C Recycle of Parts into Thermoplastic

The reprocessability of IE 7-9 under conditions to prepare a thermoset material are also provided herein. Here, the crosslinked plaques IE 7-9 produced above were reprocessed at a temperature of 160-180° C. to form thermoset compression molded pucks. The plaques of IE 7-9 were chopped into pieces and compression molded into 1.2 inch diameter, 0.5 inch thick pucks at 160-180° C. for 15 min on a Carver molder as described in Table 5 below.

TABLE 5
Reprocessing of IE 7-9 into thermoset materials.

| Label | IE 15 | IE 16 | IE 17 | CS 2 (Comparative) |
|---|---|---|---|---|
| Recycled | ENGAGE ™ 8842 | ENGAGE ™ 8100 | INFUSE ™ 9000 Blends | ENGAGE ™ 8842 |
| materials | Blends after | Blends after molding | after molding then | Blends after molding |
| description | molding then | then recycled | recycled | then recycled |
| | recycled | | | |
| Equipment | Shredder/Compression | Shredder/Compression | Shredder/Compression | Shredder/Compression |
| | molder | molder | molder | molder |
| Recycle | IE 7 | IE 8 | IE 9 | IE 7 |
| Materials | | | | |
| Compression | 160-180 | 160-180 | 160-180 | 230 |
| molding | | | | |
| temperature | | | | |
| (° C.) | | | | |
| Time (min) | 15 | 15 | 15 | 15 |
| Compression | 3000 | 3000 | 3000 | 3000 |
| molding | | | | |
| pressure (psi) | | | | |
| Outcome of | Reformed parts | Reformed parts with | Reformed parts with | Reformed parts |
| products | with thermoset | thermoset properties | thermoset properties | without thermoset |
| | properties | | | properties (tensile |
| | | | | strength at 80° C. |
| | | | | decreased by 80% |
| | | | | compared to |
| | | | | materials molded at |
| | | | | 180° C. |

As seen in Table 5, each of the inventive samples IE 15-17 which were reprocessed at a temperature of 160-180° C. produced materials with thermoset properties that could be reformed into parts. Whereas comparative sample (CS2) which was reprocess at a temperature of 230° C. resulted in the absence of thermoset properties. The tensile strength of CS2 at 80° C. decreased by 80% compared to IE 15 which was molded at 180° C. Accordingly, the CS2 molded at 230° C. was found no longer to have thermoset properties due to the irreversible breaking of the disulfide bonds.

It is specifically intended that the present disclosure not be limited to the embodiments and illustrations contained herein, but include modified forms of those embodiments including portions of the embodiments and combination of elements of different embodiments as come within the scope of the following claims.

1. A process comprising:
feeding into a mixing device components comprising
(i) a (polar) ethylene-based polymer having a melt temperature, Tm,
(ii) a free radical initiator having a decomposition temperature, T_{decomp}, and
(iii) 2,2,6,6-tetramethyl-4-piperidyl methacrylate disulfide (BiTEMPS methacrylate);
mixing, in the mixing device, components (i), (ii), and (iii) at a temperature less than the decomposition temperature of the free radical initiator; and
forming a crosslinkable polymer composition comprising the (polar) ethylene-based polymer the BiTEMPS methacrylate, and the free radical initiator.

2. The process of claim 1 comprising mixing at a temperature from greater than or equal to the melt temperature of the (polar) ethylene-based polymer to less than the decomposition temperature of the free radical initiator.

3. The process of claim 1 wherein the free radical initiator is dicumyl peroxide and the process comprises mixing at a temperature less than 140° C.

4. The process of claim 3 wherein the process comprises mixing at a temperature from 80° C. to less than 140° C.

5. The process of claim 1 comprising collecting the crosslinkable polymer composition as pellets, one or more bales, and a combination of pellets and one or more bales.

6. The process of claim 1 comprising
heating the crosslinkable polymer composition to a crosslinking temperature from 160° C. to less than 199° C.;
shaping at the crosslinking temperature, the crosslinkable polymer composition into a pre-form;
cooling the pre-form to below the crosslinking temperature; and
forming a crosslinked article.

7. The process of claim 6 wherein the crosslinked article comprises
(i) the (polar) ethylene-based polymer; and
(ii) linkages having a Structure 2

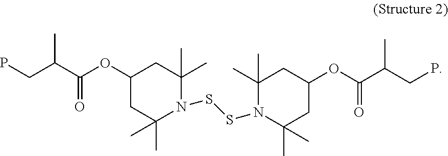

8. The process of claim 6 comprising
grinding the crosslinked article to form a grind material,
heating the grind material to a reprocessing temperature from 180° C. to 199° C.;
forming, at the reprocessing temperature, the regrind material into a re-processable (polar) ethylene-based polymer composition;
shaping, at the reprocessing temperature, the re-processable (polar) ethylene-based polymer composition into a re-processed pre-form;
cooling the re-processed pre-form to below the reprocessing temperature; and
forming a reprocessed crosslinked article.

9. The process of claim 6 comprising
heating the crosslinked article to a reprocessing temperature from 200° C. to less than 250° C.:
forming, at the reprocessing temperature, the crosslinked article into a re-processable (polar) ethylene-based polymer composition;
shaping, at the reprocessing temperature, the re-processable ethylene-based polymer composition into a re-processed pre-form;
cooling the re-processed pre-form to below the reprocessing temperature; and forming a reprocessed thermoplastic article
